(19) United States
(12) Patent Application Publication
(10) Pub. No.: US 2014/0376046 A1
(43) Pub. Date: Dec. 25, 2014

(54) INFORMATION PROCESSING APPARATUS, DISPLAY CONTROLLING METHOD AND COMPUTER PROGRAM

(71) Applicant: CANON KABUSHIKI KAISHA, Tokyo (JP)

(72) Inventor: Satoshi Okuma, Yokohama-shi (JP)

(21) Appl. No.: 14/306,763

(22) Filed: Jun. 17, 2014

(30) Foreign Application Priority Data
Jun. 19, 2013 (JP) 2013-128476

(51) Int. Cl. G06K 15/02

(52) U.S. Cl. CPC G06K 15/1809
USPC 358/1.15

(57) ABSTRACT

There is provided a display controlling method by which list displaying is not updated irrespective of an operation of a user. An information processing apparatus displays, on a display, a predetermined number of job data included in a printing job list of the job data of which the number increases and decreases irrespective of the direct operation of the user, in the order of the list. A CPU does not change the job data to be displayed on the display, in a case where new job data is added between job data not displayed on the display and in a case where job data not displayed on the display is deleted.

### BACKGROUND OF THE INVENTION

1. Field of the Invention

The present invention relates to a display controlling method by an information processing apparatus, by which a plurality of data are arranged and displayed like a list.

2. Description of the Related Art

An information processing apparatus such as a computer or the like having a touch panel on which a display and a touch pad are integrally formed is widely used. The information processing apparatus like this can detect an operation of a user such as a drag or a flick to the touch pad by the user's finger, and change a displaying format and a displaying position of an image displayed on the display according to the detected operation. The drag or the flick is widespread as an operation method using the touch panel because the user can intuitively operate, process or treat the displayed image by it. Incidentally, on the premise of the operation by the drag or the flick, the information processing apparatus sometimes arranges and displays data like a list. Here, it should be noted that such arranging and displaying operations may be called “list-displaying” simply. In that case, the user can select, by the drag and/or the flick, the desirable data from the plurality of the list-displayed data and browse the selected data.

There are cases where the list-displayed data is added or deleted irrespective of a direct operation of the user. For example, in a case where job data indicating a printing job are list-displayed on a printer, if a printing request from a PC (personal computer) or the like is accepted by the printer, job data corresponding to the accepted printing request is added to the list-displayed job data. Then, after printing is completed, the job data corresponding to the completed printing is deleted from the list-displayed job data. Such an operation resultantly means for the user who browses the list-displayed job data that the job data are added and deleted although the user oneself does not directly operate the printer.

In the case where the job data is added, the printer updates the list displaying such that the added job data is displayed in the displaying area thereof. On the other hand, in the case where the job data is deleted, the printer updates the list displaying such that list-displayed job data are relocated to cover (or move over) the position corresponding to the deleted job data. Besides, there are cases where the printer updates the list displaying from the head thereof every time the job data increases or decreases in number.

Conventionally, there are cases where, when the list displaying is updated by the addition or the deletion of the job data, the job data displayed till then disappears from the displaying area on the display. For this reason, there are cases where specific job data to which the user pays attention moves outside the displaying area because of the updating of the list displaying and thus disappears. To cope with such inconvenience, in Japanese Patent Application Laid-Open No. H11-345061, it is possible to finely control the job data to be displayed, by displaying a scroll bar. Therefore, a user can display the job data to which the user pays attention, by moving or shifting the scroll bar.

In Japanese Patent Application Laid-Open No. H11-345061, the user again displays the job data disappeared from the displaying area because of the increase or the decrease of the job data irrespective of the direct operation by the user, by operating the scroll bar. However, in this case, it is difficult for the user to know the fact that the list displaying has been updated. Further, if the specific job data to which the user pays attention suddenly disappears from the displaying area, the user feels confusion about the list displaying. Furthermore, in a case where the user selects the displayed job data, there are cases where the list displaying is updated at the timing of the selection of the job data and thus the user resultantly selects another unintended job data. Therefore, there is a problem that such inconvenience results in deterioration of user's operability.

### SUMMARY OF THE INVENTION

The present invention has been completed in order to solve the above problem, and an object of the present invention is to provide a display controlling technique by which list displaying is not updated irrespective of an operation of a user.

To achieve the above object, an information processing apparatus is characterized by comprising: a storing unit configured to store a list of data of which the number increases and decreases irrespective of a direct operation of a user; a displaying unit configured to include a list displaying area for displaying, among the data in the list, a predetermined number of the data in the order of the list; a list updating unit configured to add data to the list or delete the data from the list; and a controlling unit configured to control to update a content to be displayed by the displaying unit, according to the addition or the deletion of the data by the list updating unit, wherein the controlling unit controls not to change the data to be displayed in the list displaying area, when new data is added between data not displayed in the list displaying area and when data not displayed in the list displaying area is deleted.

Further features of the present invention will become apparent from the following description of exemplary embodiments with reference to the attached drawings.

### BRIEF DESCRIPTION OF THE DRAWINGS

FIG. 1 is a block diagram illustrating a hardware constitution of an information processing apparatus.

FIG. 2 is a diagram illustrating an example of job data displaying.

FIGS. 3A, 3B, 3C and 3D are diagrams for describing shifts of displaying in a case where job data is added to a printing job list.

FIGS. 4A, 4B and 4C are diagrams for describing shifts of conventional displaying in a case where job data is added to the printing job list.

FIGS. 5A, 5B, 5C and 5D are diagrams for describing shifts of displaying in a case where job data is deleted from the printing job list.

FIGS. 6A, 6B and 6C are diagrams for describing shifts of conventional displaying in a case where job data is deleted from the printing job list.

FIG. 7 is a flow chart for describing a processing procedure of the information processing apparatus.

FIGS. 8A, 8B, 8C and 8D are diagrams for describing shifts of displaying in a case where job data is added to the printing job list.

FIGS. 9A, 9B, 9C and 9D are diagrams for describing shifts of displaying in a case where job data is deleted from the printing job list.

FIG. 10 is a flow chart for describing a processing procedure of the information processing apparatus.

FIGS. 11A and 11B are diagrams for describing shifts of displaying in a case where job data is added to the printing job list.

FIGS. 12A and 12B are diagrams for describing shifts of displaying in a case where job data is deleted from the printing job list.

FIG. 13 is a flow chart for describing a processing procedure of the information processing apparatus.

### DESCRIPTION OF THE EMBODIMENTS

Preferred embodiments of the present invention will now be described in detail in accordance with the accompanying drawings.

<Hardware Constitution>

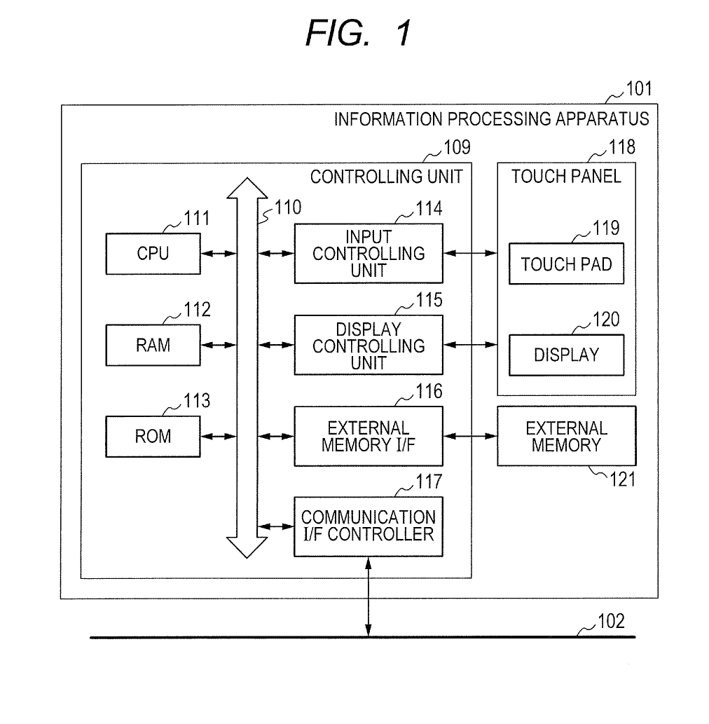

FIG. 1 is a block diagram illustrating a hardware constitution of an information processing apparatus 101 according to the present embodiment. The information processing apparatus 101 has a controlling unit 109, a touch panel 118, which has a touch pad 119 and a display 120, and an external memory 121. The controlling unit 109 has a CPU (central processing unit) 111, a RAM (random access memory) 112 and a ROM (read only memory) 113. In addition, the controlling unit 109 has an input controlling unit 114, a display controlling unit 115, an external memory I/F (interface) 116 and a communication I/F controller 117 as an input/output interface. Respective components in the controlling unit 109 are connected with each other capable of mutually performing the data transmission/reception through a system bus 110.

The CPU 111 controls each of sections in the information processing apparatus 101 by a process that the CPU 111 reads out computer programs stored in the ROM 113 and executes the read out programs by using the RAM 112 as a working area. The ROM 113 is a nonvolatile memory, in which image data and the like other than the above computer programs are stored. The RAM 112 is a volatile memory, which is used as a temporary storage area when the CPU 111 performs various processes. Incidentally, the CPU 111 may read out computer programs from the external memory 121 other than the ROM 113 and execute the read out programs.

The input controlling unit 114 generates a control signal corresponding to a user operation by using an inputting device and transmits the generated signal to the CPU 111. As the inputting device, for example, there is a character information inputting device (not illustrated) such as a keyboard, a mouse (not illustrated), the touch panel 118 or the like. The touch panel 118 is constituted by providing the transparent touch pad 119 on the display 120. The touch panel 118 transmits position information, which represents a position on the touch pad 119 touched by a user, to the input controlling unit 114. The position information on the touch panel 118 can be corresponded to displaying coordinates of an image to be displayed on the display 120. Therefore, the touch panel 118 can constitute such a GUI (graphical user interface) as if a user can directly operate an image displayed on the display 120. The input controlling unit 114 generates a control signal responding to the position information transmitted from the touch panel 118. The CPU 111 performs a process based on the control signal. In this manner, the information processing apparatus 101 can perform a process according to a user operation.

The display controlling unit 115 controls to display an image on the display 120. The display controlling unit 115 receives a display controlling signal generated by the CPU 111, generates a displaying signal based on the received display controlling signal and outputs the displaying signal to the display 120. The display controlling unit 115 controls to display, for example, a GUI screen, which constitutes the GUI, on the display 120 by using the displaying signal.

The external memory 121 can be connected with the external memory I/F 116. The external memory 121 is, for example, a hard disk, a flexible disk, a CD (compact disk), a DVD (digital versatile disk), a memory card, an SSD (solid state drive) or the like. The external memory I/F 116 reads out data from the external memory 121 and writes data in the external memory 121 on the basis of the control of the CPU 111. The communication I/F controller 117 performs communication with other apparatuses through, for example, a LAN (local area network), an internet or a network (a wired network, a wireless network or the like) 102 on the basis of the control of the CPU 111.

Processes to be performed in the touch panel 118 and the CPU 111 will be described in detail. The CPU 111 detects the following operations performed to the touch panel 118 by a user or the state of the touch panel 118. Although a finger of user or a stylus pen can be used for an operation of the touch panel 118, it will be simply written as “finger” in the following description.
touch down: a fact that a finger touches the touch pad 119
touch on: a state that a finger is kept to touch the touch pad 119
move: a fact that a finger moves while keeping to touch the touch pad 119
touch up: a fact that a finger kept to touch the touch pad 119 separates from the touch pad 119
touch off: a state that anything does not touch the touch pad 119
drag: a series of operations from the touch down to the touch up, wherein an operation of the move is performed
flick: an operation of quickly performing the drag in one direction

The input controlling unit 114 generates a control signal on the basis of these operations or position information representing a touching position of finger on the touching pad 119 and informs the control signal to the CPU 111. The CPU 111 judges that what kind of operation has been performed on the touch pad 119 on the basis of the control signal.

As to the “move”, the CPU 111 also judges a movement direction every vertical component and horizontal component of the movement of a finger, which moves on the touch pad 119, by a temporal change of the position information. A user can obtain such an operation feeling as actually moving an image displayed on the display with a finger by a process that the CPU 111 controls to move an image to be displayed on the display 120 according to the judged result. At this time, the movement distance or the direction in the “move” becomes the same as that of an image on the display. The CPU 111 can calculate the movement distance in the “move” from position information of a finger on the touch panel 118.

As for the touch panel 118, any system may be used among various systems of touch panel such as a resistive type, an electrostatic type, a surface acoustic wave type, an infrared ray type, an electromagnetic induction type, an image recognition type, an optical sensor type and the like.

<List Displaying Process>

The information processing apparatus 101 illustrated in FIG. 1 can be used for, for example, an image forming system which has an image forming apparatus (printer) and an image reading apparatus (scanner). Operations of the printer and the scanner, which are connected with the system bus 110 of the information processing apparatus 101, are controlled by the information processing apparatus 101.

In the image forming system, image data generated by optically reading a paper medium by the scanner is stored in the RAM 112 of the information processing apparatus 101. The CPU 111 transmits the image data stored in the RAM 112 to the printer. The printer receives the image data transmitted from the CPU 111 and prints out the image data on another paper medium. In this manner, a series of processes, where the image data obtained by reading the paper medium by the scanner is printed out on another paper medium by the printer, represent a “copying process”. Further, in the image forming system, image data is received from another apparatus such as a PC or the like connected with the network 102 through the communication I/F controller 117 and then the image data is printed out on the paper medium by the printer. A process of printing out the image data received from another apparatus on the paper medium represents a “printing process”. In the present specifications, each process in the copying process and the printing process is called a “printing job”.

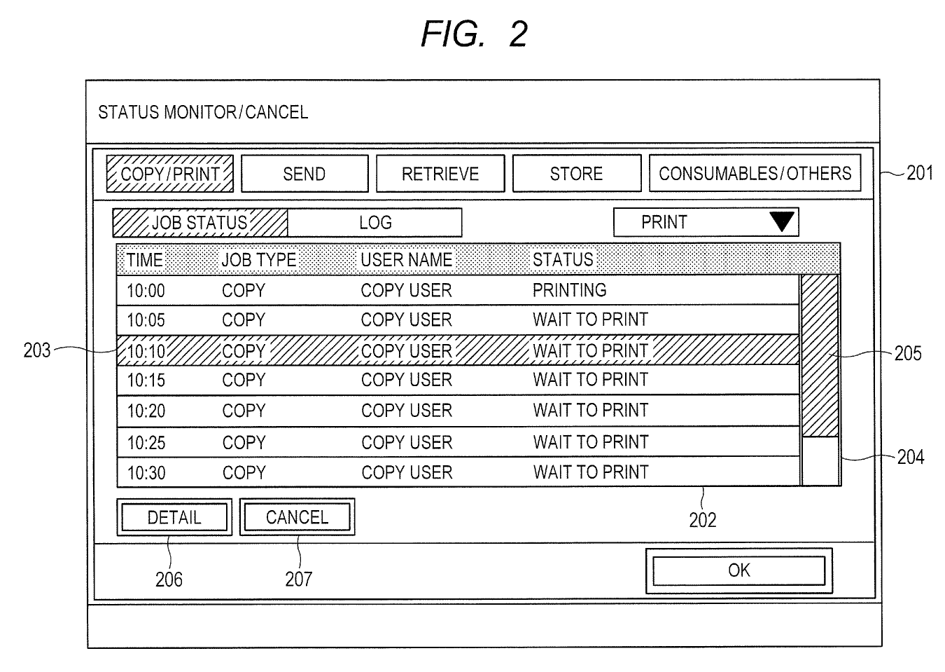

The printing jobs are displayed in a list on the display 120 as job data. A list of job data of all the printing jobs which have been input in the image forming system is stored in the RAM 112 as a printing job list. The CPU 111, which performs a list management of the printing job list, adds the concerned job data to or deletes the concerned job data from the printing job list in accordance with addition and deletion of the printing job. Therefore, the job data increases or decreases regardless of a direct operation of a user. The CPU 111 reads out the printing job list from the RAM 112 and creates a list of job data, of which the number is in such a level as can be displayed on the display, in case of displaying a list, and the created list is displayed on the display 120 by the display controlling unit 115. FIG. 2 is a diagram illustrating an example of a displaying screen when displaying a list of such the job data.

A displaying screen 201 to be displayed on the display 120 displays the conditions, information and the like of the printing job. A list displaying area 202 is provided within the displaying screen 201. The predetermined numbers of job data are displayed in the order of list in the list displaying area 202. In the present embodiment, job data are displayed in a list with a state of lining up in the vertical direction. In an example of FIG. 2, seven job data can be displayed in the list displaying area 202 at the maximum level. In a case that seven or more job data have been input, job data which is in the outside of the list displaying area 202 can be displayed by performing the flick or move in the list displaying area 202.

In FIG. 2, an acceptance time of day of the corresponded printing job, a type of the printing job, a user name who executes the printing job, a status of the printing job are displayed for one job data. If a printing job is added, job data is added to the printing job list. In a case that an execution of the printing job was completed or the printing job was canceled, job data of the printing job is deleted from the printing job list. The addition of job data to or the deletion of the job data from the printing job list can be performed regardless of an operation of a user who browses the displaying screen 201. The displayed contents in the list displaying area 202 are automatically updated every addition of job data to or the deletion of the job data from the printing job list.

In addition, the job data to be displayed in the list displaying area 202 is selected by an operation that a user touches down a position of the job data. The selected job data indicates that the job data is in a state of being selected by use of the color change or the displaying of a mark or the like. Job data 203 indicates that the job data is being selected by use of the color change. A user can perform a process to the selected job data. Detailed information of a printing job of the selected job data is displayed by an operation that the user selects a detail button 206 after selecting the job data. The printing job of the selected job data is stopped by an operation that the user selects a stop button 207 after selecting the job data. The user can release a selecting state by touching down a position of the selected job data again.

A scroll bar 204 is provided in the list displaying area 202. The user can operate a scroll bar slider 205 in the scroll bar 204. If seven or more printing job data exist, the job data which is in the outside of the list displaying area 202 can be displayed by flicking or moving the scroll bar slider 205.

The length of the scroll bar slider 205 varies in accordance with a rate of the number of job data currently displayed in the list displaying area 202 to the number of all the job data in the printing job list. In a case that all the job data in the printing job list are displayed in the list displaying area 202, the length of the scroll bar 204 coincides with the length of the scroll bar slider 205. In a case that a half of the job data in the printing job list are displayed in the list displaying area 202, the length of the scroll bar slider 205 becomes half of that of the scroll bar 204.

A displaying position of the scroll bar slider 205 indicates a position of the job data currently displayed in the list displaying area 202 for all the job data in the printing job list. In a case that the number of job data in the printing job list is larger than the number of job data which can be displayed in the list displaying area 202 and a former part in the printing job list is displayed in the list displaying area 202, the scroll bar slider 205 is displayed on an upper half position of the scroll bar 204. In a case that a latter part in the printing job list is displayed in the list displaying area 202, the scroll bar slider 205 is displayed on a lower half position of the scroll bar 204.

In a case that the number of job data in the printing job list is larger than the number of job data which can be displayed in the list displaying area 202, when the job data is added to or deleted from the printing job list, the length of the scroll bar slider 205 varies. When a displaying position of the job data changes after an operation of the flick or move is performed in the list displaying area 202, a relative position of the scroll bar slider 205 to the scroll bar 204 varies.

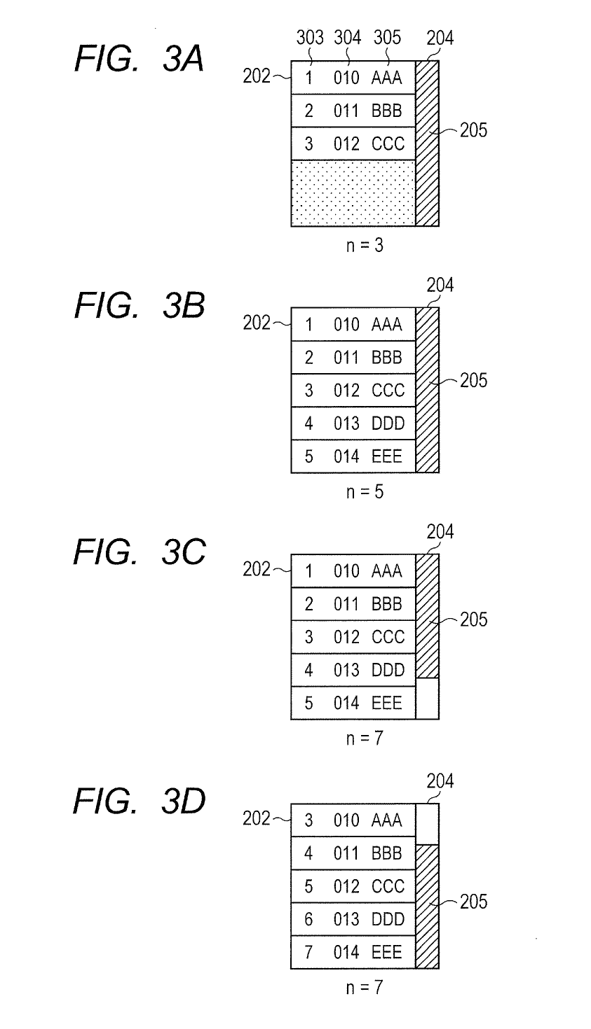

FIGS. 3A to 3D, FIGS. 4A to 4C, FIGS. 5A to 5D and FIGS. 6A to 6C are diagrams, which simplify the list displaying area 202 illustrated in FIG. 2. In FIGS. 3A to 6C, it is assumed that the number N (N denotes natural numbers) of job data which can be displayed in the list displaying area 202 is “5”. It is assumed that the number of all the job data in the printing job list is n (n denotes integers equal to or larger than 0).

Each job data in the list displaying area 202 includes a data number 303, which indicates that it is what number of the job data from the head in the printing job list, a data ID 304, which is used for identifying the job data, and a data name 305. A value of the data number 303 varies by the addition of job data to or deletion of job data from the printing job list. The data ID 304, which is uniquely determined when adding the job data to the printing job list, does not vary until the job data is deleted. The data name 305, which is a name used for specifying the job data, is not changed until the job data is deleted. Incidentally, the data name 305 may be the same name for a plurality of job data. For example, a name of the printing job, a user name who executed the printing job, a type of the printing job and the like are displayed for the data name 305. For example, a receipt number of the printing job is displayed for the data ID 304. The data number 303, the data ID 304 and the data name 305 are selectively displayed in the list displaying area 202, and also there is a case that these items are not displayed.

FIGS. 3A to 3D are diagrams indicating shifts of displaying when job data is added to the printing job list. FIG. 3A illustrates an initial state of the list displaying area 202, and the job data is added with this state. FIG. 3A is a displaying example of the list displaying area 202 when the number n is in a state of “n=3”. In the list displaying area 202, three job data, of which the data name 305 are “AAA”, “BBB” and “CCC”, are displayed.

FIG. 3B is a displaying example when two job data, of which the data name 305 are “DDD” and “EEE”, are added to the list displaying area 202 illustrated in FIG. 3A. The numbers n and N are resulted in a state of “n=5” and “n=N” according to a fact that the two job data are added. As all job data are displayed in the list displaying area 202, the length of the scroll bar 204 and the length of the scroll bar slider 205 become the same length.

FIG. 3C is a displaying example when two job data, of which the data name 305 are “FFF” and “GGG”, are added to the tail end of the list displaying area 202 illustrated in FIG. 3B. The numbers n and N are resulted in a state of “n=7” and “n>N” according to a fact that the two job data are added. As the two job data are added to the end of the job data being displayed in the list displaying area 202 illustrated in FIG. 3B, the displaying of the list displaying area 202 does not vary. Since the number n is in a state of “n=7”, the scroll bar slider 205, of which the length is 5/7 length of that of the scroll bar 204, is displayed in the scroll bar 204. Since the job data are displayed from the head job data, which is in the printing job list, in the list displaying area 202, the scroll bar slider 205 positions at the upper part of the scroll bar 204.

FIG. 3D is a displaying example when two job data, of which the data name 305 are “YYY” and “ZZZ”, are added to the ahead of the head job data “AAA” in the list displaying area 202 illustrated in FIG. 3B. The numbers n and N are resulted in a state of “n=7” and “n>N” according to a fact that the two job data are added. The data number 303 is updated by an operation that the two job data are added to the ahead of the job data being displayed in the list displaying area 202 illustrated in FIG. 3B. Since the number n is in a state of “n=7”, the scroll bar slider 205, of which the length is 5/7 length of that of the scroll bar 204, is displayed in the scroll bar 204. Since the job data are displayed from the rear job data, which is in the printing job list, in the list displaying area 202, the scroll bar slider 205 positions at the lower part of the scroll bar 204.

As illustrated in FIGS. 3B, 3C and 3D, even if the job data is newly added to the end or head of the printing job list, a displaying position of the job data already displayed in the list displaying area 202 does not vary. Therefore, even in a case that a user has been paying attention to specific job data, sight of the job data, to which the user has been paying attention, is not lost by the addition of new job data.

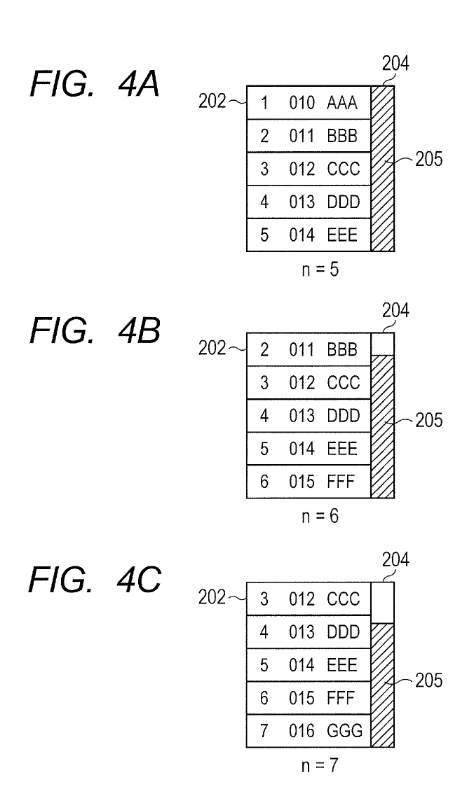

FIGS. 4A to 4C are diagrams for exemplifying the list displaying when performing the conventional job data addition in order to compare with the list displaying in FIGS. 3A to 3D. FIG. 4A is a displaying example of the list displaying area 202 when the number n is in a state of “n=5”. The job data, of the data name 305 are “AAA” to “EEE”, are displayed in the list displaying area 202. FIG. 4A corresponds to FIG. 3B.

FIG. 4B is a displaying example when the job data, of which the data name 305 is “FFF”, is added to the tail end of the list displaying area 202 illustrated in FIG. 4A. Since the numbers n and N are resulted in a state of “n=6” and “n>N” according to a fact that the one job data is added, the job data, of which the data name 305 is “AAA”, deviates from the list displaying area 202, and the job data, of which the data name 305 are “BBB” to “EEE”, move upward one by one. The added job data, of which the data name 305 is “FFF”, is displayed at the lowest row. In this case, there appears confusion for a user who has been paying attention to the job data, of which the data name 305 is “AAA”, because the job data, to which the attention has been paid, disappears from the list displaying area 202. There appears confusion for also a user who has been paying attention to the job data, of which the data name 305 are “BBB” to “EEE”, because the displaying positions are moved.

FIG. 4C is a displaying example when the job data, of which the data name 305 is “GGG”, is further added in FIG. 4B. Similar to a case in FIG. 4B, the job data, of which the data name 305 is “BBB”, deviates from the list displaying area 202 due to the addition of the job data. As above, since the job data, which is being displayed in the list displaying area 202, deviates from the list displaying area or the displaying position is moved due to the addition of the job data, a user who has been paying attention to the specific job data is resulted to feel confusion.

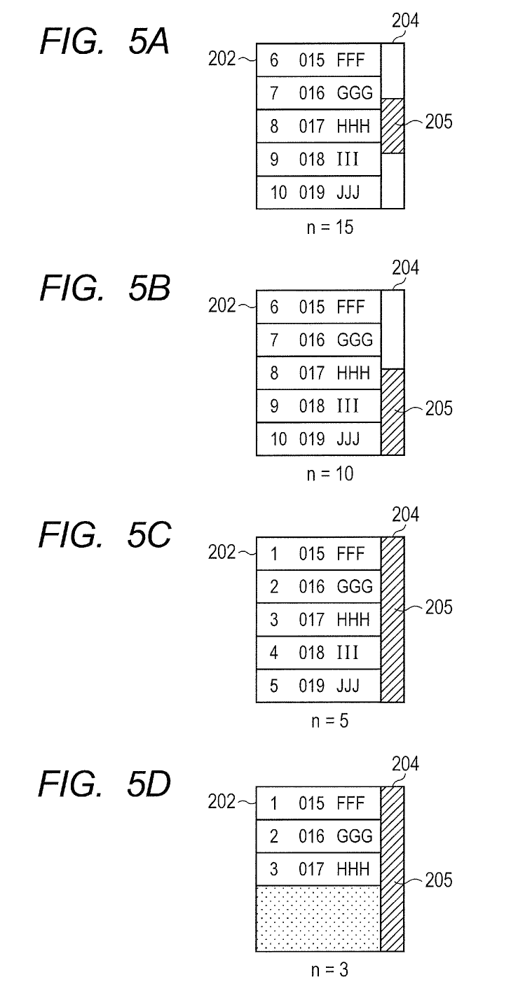

FIGS. 5A to 5D are diagrams illustrating shifts of displaying when the job data is deleted from the printing job list. FIG. 5A indicates an initial state of the list displaying area 202, and the job data is deleted from this state. FIG. 5A is a displaying example of the list displaying area 202 when the number n is in a state of “n=15”. Fifteen job data, of which the data name 305 are “AAA” to “OOO”, configure the printing job list, and sixth to tenth job data (“FFF” to “JJJ”) in this printing job list are displayed in the list displaying area 202. Since the job data corresponding to middle ⅓ of fifteen job data are displayed, the length of the scroll bar slider 205 becomes ⅓ length of that of the scroll bar 204, and a displaying position of the scroll bar slider 205 becomes a center position of the scroll bar 204.

FIG. 5B is a displaying example of the list displaying area 202 when five job data, of which the data number 303 are “11 to 15”, are deleted. The number n becomes to be in a state of “n=10”, and the job data, of which the data name 305 is “JJJ”, becomes the tail end in the printing job list. Since the deleted job data is not displayed in the list displaying area 202, the displaying of the list displaying area 202 is maintained as it is. The length of the scroll bar slider 205 becomes half length of that of the scroll bar 204, and the scroll bar slider 205 positions at the lower part of the scroll bar 204.

FIG. 5C is a displaying example of the list displaying area 202 when five job data, of which the data number 303 are “1 to 5”, are further deleted from FIG. 5B. The number n becomes to be in a state of “n=5”, and the job data, of which the data name 305 is “FFF”, becomes the head in the printing job list. The data number 303 is updated in accordance with a fact that five job data, of which the data number 303 are “1 to 5”, are deleted. Since the numbers n and N becomes to be in a state of “n=N”, the length of the scroll bar slider 205 becomes the same length as that of the scroll bar 204.

FIG. 5D is a displaying example of the list displaying area 202 when two job data, of which the data name 305 are “III” and “JJJ”, are further deleted from FIG. 5C. The numbers n and N become to be in a state of “n=3” and “n<N”, and the two job data, of which the data name 305 are “III” and “JJJ”, are deleted from the list displaying area 202.

As above, even in a case that the job data is deleted from the printing job list, a displaying position of the job data, which has been already displayed in the list displaying area 202, does not vary. Therefore, even in a case that a user has been paying attention to specific job data, sight of the job data, to which the user has been paying attention, is not lost by the deletion of another job data.

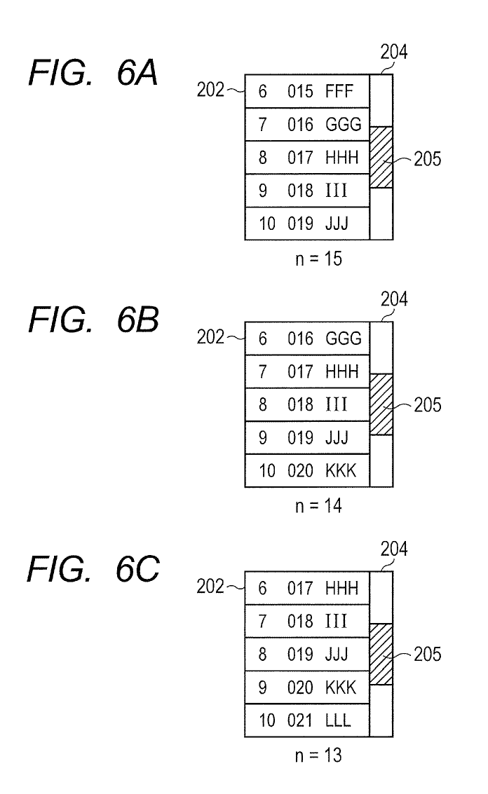

FIGS. 6A to 6C are diagrams for exemplifying the list displaying when performing the conventional job data deletion in order to compare with the list displaying in FIGS. 5A to 5D. FIG. 6A is a displaying example of the list displaying area 202 when the number n is in a state of “n=15”. Fifteen job data, of which the data name 305 are “AAA” to “OOO”, configure the printing job list. The displaying of the list displaying area 202 in FIG. 6A becomes similar to that of the list displaying area 202 in FIG. 5A.

FIG. 6B is a displaying example when the head job data (“AAA”) has been deleted from the printing job list illustrated in FIG. 6A. Since the head job data in the printing job list is deleted, the displaying of the job data, of which the data name 305 is “FFF”, to be displayed in the list displaying area 202 deviates from the list displaying area 202, and the job data, of which the data name 305 are “GGG” to “JJJ”, move upward one by one. Further, the job data, of which the data name 305 is “KKK”, which has not been displayed, is displayed in the list displaying area 202.

FIG. 6C is a displaying example, when the job data, of which the data name 305 is “BBB”, is further deleted in FIG. 6B. Similar to a case in FIG. 6B, the job data, of which the data name is “GGG”, to be displayed in the list displaying area 202 deviates from the list displaying area 202, and the job data, of which the data name 305 are “HHH” to “KKK”, move upward one by one. Further, the job data, of which the data name 305 is “LLL”, which has not been displayed, is displayed in the list displaying area 202.

As above, since the displaying is updated regardless of whether or not the job data is displayed in the list displaying area 202 due to the deletion of the job data, this situation becomes the cause that makes the user feel confusion.

According to the present embodiment, even if there occurs the addition or deletion of the job data, if it is not the addition to or deletion from the job data currently displayed in the list displaying area 202, the displaying in the list displaying area 202 is maintained as it is. Therefore, even in a case that the user has been paying attention to the job data to be displayed in the list displaying area 202, the job data, to which the attention has been paid, does not deviate from the list displaying area 202 by the addition or deletion of another job data, and the user does not lose sight of the job data. In addition, an erroneous operation, where the user selects an erroneous job data because a displaying position of the job data is shifted at the moment when the user intends to select the job data, can be prevented.

<Processing Procedure>

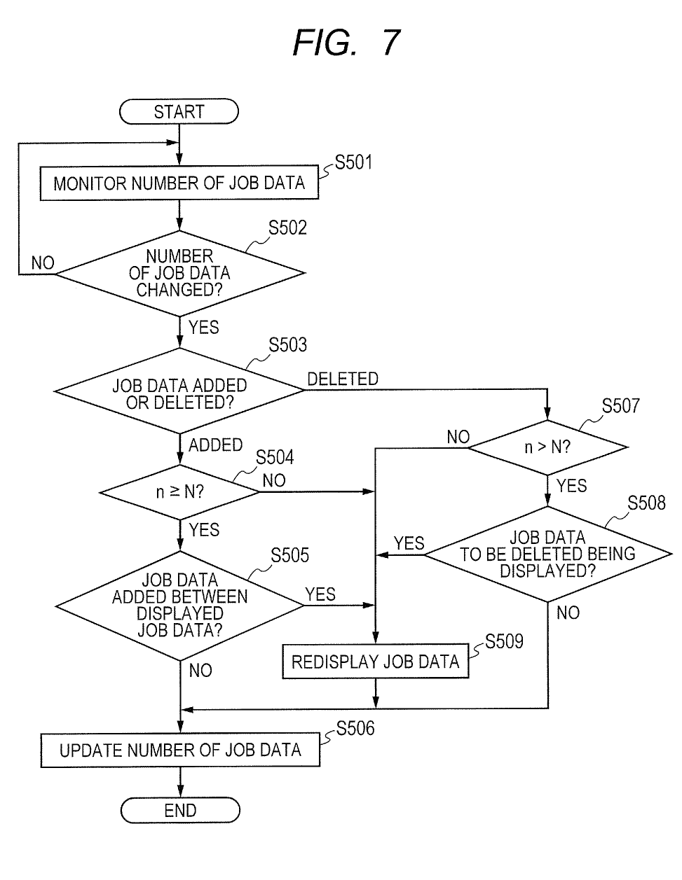

FIG. 7 is a flow chart indicating a processing procedure of the information processing apparatus 101 in order to realize the displaying as in FIGS. 3A to 3D and FIGS. 5A to 5D. Each of the steps in this flow chart is completed by a process that the CPU 111 executes control programs stored in the ROM 113 or the external memory 121.

The CPU 111 monitors generation of the change of the number of job data included in the printing job list in the course of displaying the displaying screen 201 on the display 120 (S501). The CPU 111 can detect generation of the change of the number of job data by monitoring the addition of the printing job, the completion of the printing job and the deletion of the printing job due to the cancellation. When generating the change of the number of job data (“YES” in S502), the CPU 111 judges whether the job data is added or deleted (S503).

When the job data is added to the printing job list (“ADDED” in S503), the CPU 111 judges whether or not the number of all the job data n in the printing job list before adding the job data is equal to or larger than the number N which can be displayed in the list displaying area 202 (S504).

In a case that the numbers n and N are in a state of “n<N” (“NO” in S504), the CPU 111 changes a displaying position of the job data and redisplays the job data in the list displaying area 202 (S509). The CPU 111 determines a displaying position of the job data, which is to be added, based on the data number 303 to be assigned to the job data which is to be added. The CPU 111 displays the job data added to a determined displaying position and changes positions of other job data in accordance with the displaying position of the added job data.

In a case that the numbers n and N are in a state of “n>N” (“YES” in S504), the CPU 111 judges whether or not the added job data is displayed between the job data currently displayed in the list displaying area 202 (S505). The CPU 111 gives a judgment according to a fact whether or not, for example, the data number 303 to be assigned to the added job data enters between the data number 303 of the job data which are currently displayed in the list displaying area 202. In a case that the added job data is displayed between the job data which are currently displayed (“YES” in S505), the CPU 111 changes a displaying position of the job data and redisplays the job data in the list displaying area 202 (S509).

In a case that the added job data is not displayed between the job data which are currently displayed (“NO” in S505), the CPU 111 updates the number of all the job data n in the printing job list (S506) and terminates a series of processes. In this case, a displaying position of the printing job list to be displayed in the list displaying area 202 is not changed.

In a case that the job data is deleted from the printing job list (“DELETED” in S503), the CPU 111 judges whether or not the number of all the job data n in the printing job list before deleting the job data is larger than the number N which can be displayed in the list displaying area 202 (S507).

In a case that the numbers n and N are in a state of “n>N” (“YES” in S507), the CPU 111 confirms whether or not the job data to be deleted is the job data currently displayed in the list displaying area 202 (S508). The CPU 111 confirms whether or not the job data to be deleted is the job data currently displayed based on, for example, the data number of the job data to be deleted. In a case that the job data to be deleted is not currently displayed in the list displaying area 202 (“NO” in S508), the CPU 111 updates the number of all the job data n in the printing job list (S506) and terminates a series of processes. In this case, a displaying position of the printing job list to be displayed in the list displaying area 202 is not changed.

In a case that the numbers n and N are in a state of “n<N” in S507 (“NO” in S507), or in a case that the job data to be deleted is currently displayed in the list displaying area 202 in S508 (“YES” in S508), the CPU 111 performs a process of S5509. The CPU 111 deletes the job data, which is to be subjected, from the job data displayed in the list displaying area 202 and redisplays the job data in the list displaying area 202 after changing a position of the job data in accordance with necessity (S509).

As above, in a case that the job data to be added is not displayed in the list displaying area 202, the information processing apparatus 101 does not update the job data to be displayed in the list displaying area 202. In addition, in a case that the job data to be deleted is not displayed in the list displaying area 202, the information processing apparatus does not update the job data to be displayed in the list displaying area 202. Therefore, in a case that a user has been paying attention to the job data displayed in the list displaying area 202, even if the addition or deletion of the job data is performed, it become rare to lose sight of the job data. Further, the possibility of an erroneous operation, where the user selects an erroneous job data because a displaying position of the job data is shifted when the user intends to select the job data, can be reduced.

<Process 1 when User is Selecting Job Data>

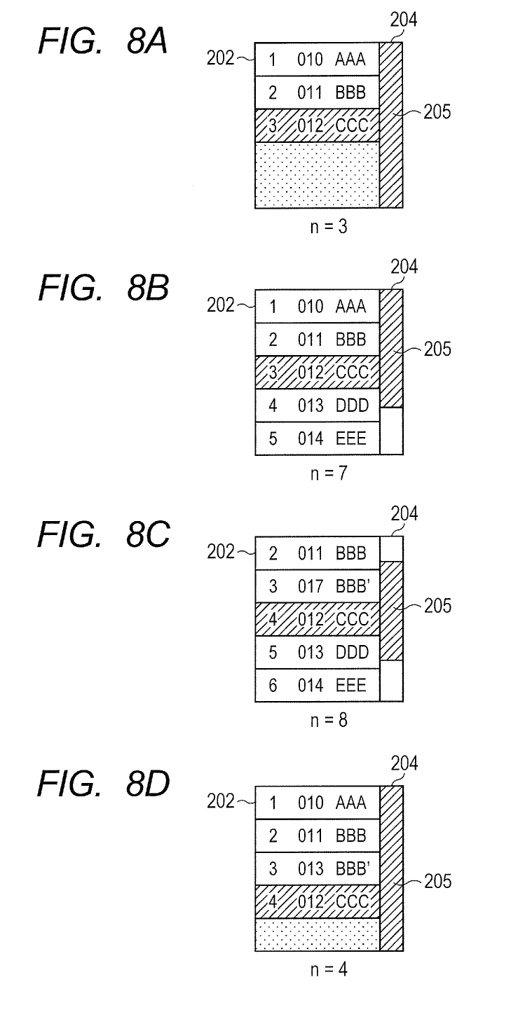

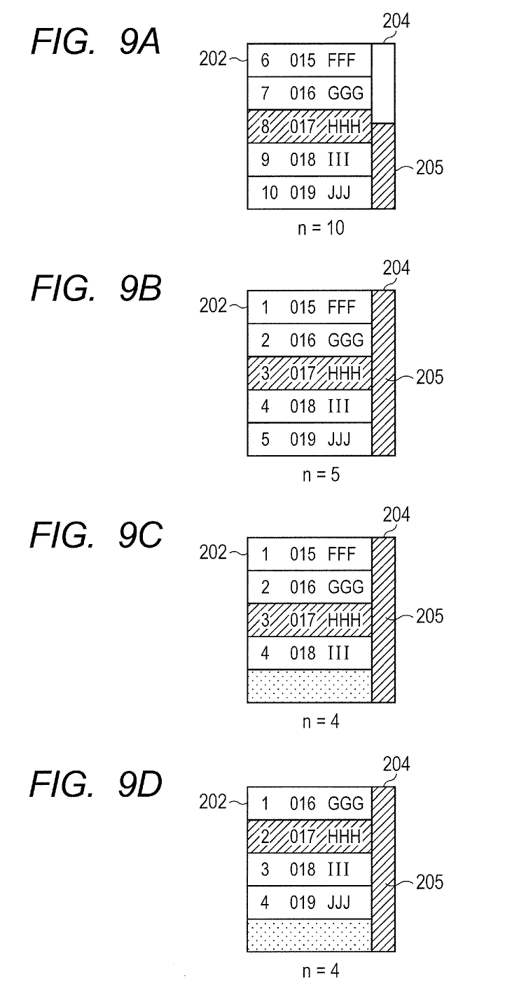

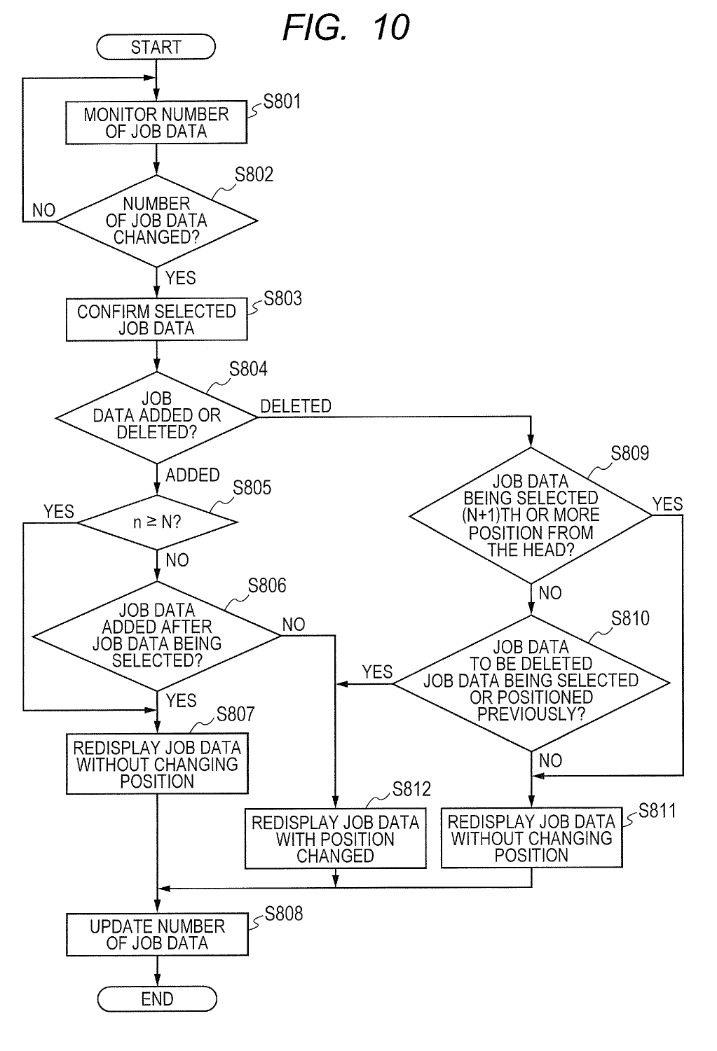

When the job data displayed in the list displaying area 202 is being selected by a user, if the job data is added to or deleted from the printing job list, the information processing apparatus 101 performs the following processes. FIGS. 8A to 8D and FIGS. 9A to 9D are diagrams which simplify the list displaying area 202 illustrated in FIG. 2. In FIGS. 8A to 8D and FIGS. 9A to 9D, the number of job data N, which can be displayed in the list displaying area 202, is “5”.

FIGS. 8A to 8D are diagrams illustrating shifts of displaying when the job data is added to the printing job list. FIG. 8A is a displaying example of the list displaying area 202 when the number n is in a state of “n=3”. Three job data, of which the data name 305 are “AAA”, “BBB” and “CCC”, are displayed in the list displaying area 202. The job data, of which the data name 305 is “CCC”, is in a state of selected by a user, and this job data is displayed with a displaying form different from that of other job data.

FIG. 8B is a displaying example when the job data are added to the list displaying area 202 in FIG. 8A. In FIG. 8B, four job data, of which the data name 305 are “DDD”, “EEE”, “FFF” and “GGG”, are added, and the number n becomes to be in a state of “n=7”. The number of job data n after adding the job data is in a state of “n>N”, and the job data, of which the data name 305 currently displayed is “CCC”, is in a state of selected by the user. Therefore, the added job data is displayed in a manner that a displaying position of the selected job data, of which the data name 305 is “CCC”, is not shifted. In order that a displaying position of the job data, of which the data name 305 is “CCC”, is not shifted, the head portion of the printing job list is resulted to be continuously displayed as it is. Since the number n is in a state of “n=7”, the length of the scroll bar slider 205 becomes 5/7 length of that of the scroll bar 204, and the scroll bar slider 205 is displayed in such a way as to position at the upper part of the scroll bar 204.

FIG. 8C is a displaying example when the job data, of which the data name 305 is “BBB′”, is added between the job data of which the data name 305 are “BBB” and “CCC” for the state in FIG. 8B. The number of job data n after adding the job data is in a state of “n>N”, and the job data, of which the data name 305 currently displayed is “CCC”, is in a state of selected by the user. Therefore, the added job data is displayed in a manner that a displaying position of the selected job data, of which the data name 305 is “CCC”, is not shifted. In order that a displaying position of the job data, of which the data name 305 is “CCC”, is not shifted, the job data, of which the data name 305 is “AAA”, deviates from the list displaying area 202 and this job data becomes not to be displayed as a result. Since the number n is in a state of “n=8”, the length of the scroll bar slider 205 becomes ⅝ length of that of the scroll bar 204, and the scroll bar slider 205 is displayed on such a position slightly lower from an upper end of the scroll bar 204.

FIG. 8D is a displaying example when the job data, of which the data name 305 is “BBB′”, is added between the job data of which the data name 305 are “BBB” and “CCC”, in FIG. 8A. Since the number of job data n after adding the job data is in a state of “n<N”, the job data is displayed in orderly sequence from the head of the printing job list. A position of the job data, of which the data name 305 is “CCC”, selected by the user moves downward by one line for the state in FIG. 8A, and this job data is displayed on a fourth position from the upper position. However, the job data, which is in a selected state, does not deviate from the list displaying area 202 by the addition of the job data.

FIGS. 9A to 9D are diagrams illustrating shifts of displaying when the job data is deleted from the printing job list. FIG. 9A is a displaying example of the list displaying area 202 when the number n is in a state of “n=10”. Ten job data, of which the data name 305 are “AAA” to “JJJ”, configure the printing job list, and the latter five job data in this printing job list are displayed in the list displaying area 202. The length of the scroll bar slider 205 becomes half length of that of the scroll bar 204, and the scroll bar slider 205 is displayed on the rear edge part of the scroll bar 204. The job data, of which the data name 305 is “HHH”, is in a state of selected by the user, and this job data is displayed with a displaying form different from that of other job data.

FIG. 9B is a displaying example when five job data arranged from the head in the printing job list are deleted in FIG. 9A and the number n becomes to be in a state of “n=5”. The number of job data after deleting the job data is “5”, and the numbers n and N become to be in a state of “n=N”. The job data is displayed in the list displaying area 202 in a manner that a displaying position of the job data selected in the list displaying area 202 is not shifted. Since the deleted head job data, of which the data name 305 are “AAA” to “EEE”, have not been displayed in the list displaying area 202, the displaying of the list displaying area 202 is not changed. The length of the scroll bar slider 205 is changed to become the same length as that of the scroll bar 204.

FIG. 9C is a displaying example when the job data, of which the data name 305 is “JJJ”, is further deleted from FIG. 9B. In this case, although the numbers n and N are in a state of “n<N”, since the job data after the job data selected by the user is deleted, the displaying of the list displaying area 202 is updated without shifting a displaying position of the job data selected by the user.

FIG. 9D is a displaying example when the job data, of which the data name 305 is “FFF”, is further deleted from FIG. 9B. In this case, the numbers n and N are in a state of “n<N”, and since the job data before the job data selected by the user is deleted, a displaying position of the job data selected by the user is shifted and moved to a second position from the upper position of the list displaying area 202. However, also in this case, the job data selected by the user does not deviate from the list displaying area 202.

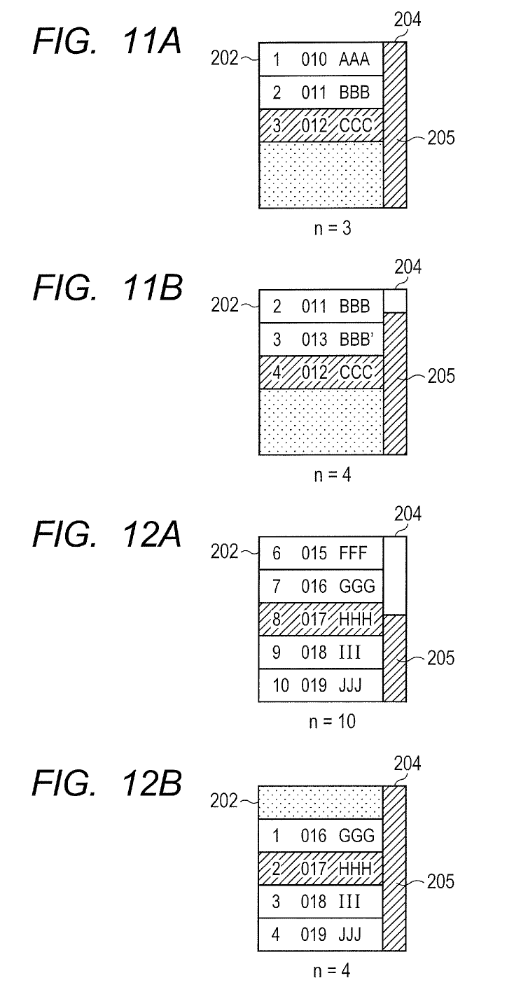

FIG. 10 is a flow chart indicating a processing procedure of the information processing apparatus 101 in order to realize the displaying as in FIGS. 8A to 8D and FIGS. 9A to 9D. Each of the steps in this flow chart is completed by a process that the CPU 111 executes control programs stored in the ROM 113 or the external memory 121.

Processes in S801 and S802 are the same as those in S501 and S502 in FIG. 7, the description thereof will be omitted. When the number of job data included in the printing job list varies (“YES” in S802), the CPU 111 confirms the job data being selected by the user (S803). The CPU 111, for example, confirms the job data selected by the user according to the relationship between a position of the job data displayed in the list displaying area 202 and a position touched by the user on the touch pad 119. Incidentally, in a case that the job data selected by the user does not exist, the process becomes the same process as that in FIG. 7.

After confirming the job data to be selected by the user, the CPU 111 judges whether the job data is added or deleted (S804). In a case that the job data is added (“ADDED” in S804), the CPU 111 judges whether or not the number of all the job data n in the printing job list before adding the job data is equal to or larger than the number N which can be displayed in the list displaying area 202 (S805).

In a case that the numbers n and N are in a state of “n<N” (“NO” in S805), the CPU 111 judges whether or not the job data to be added is added after the job data which is in a state of being selected (S806). In a case that the job data is added before the job data which is in a state of being selected (“NO” in S806), the CPU 111 changes a displaying position of the job data and redisplays the job data in the list displaying area 202 (S812). In a case that the job data is added after the job data which is in a state of being selected (“YES” in S806), the CPU 111 adds the job data without moving a position of the job data which is in a state of being selected and redisplays the job data in the list displaying area 202 (S807). Incidentally, even in a case that the numbers n and N are in a state of “n>N” in S805 (“YES” in S805), the CPU 111 adds the job data without moving a displaying position of the job data which is in a state of being selected and redisplays the job data in the list displaying area 202 (S807).

In a case that the job data is deleted from the printing job list in S804 (“DELETED” in S804), the CPU 111 judges whether or not the job data, which is in a state of being selected, positions at (N+1)th or more position from the head of all the job data in the printing job list (S809). When it was judged that the job data, which is in a state of being selected, positions at (N+1)th or more position from the head of all the job data in the printing job list (“YES” in S809), the CPU 111 redisplays the job data in the list displaying area 202 without changing a displaying position of the job data (S811).

When it was judged that the job data, which is in a state of being selected, does not position at (N+1)th or more position from the head of all the job data in the printing job list (“NO” in S809), the CPU 111 performs a process to be performed in S810. In S810, the CPU 111 judges whether the job data to be deleted is the job data, which is in a state of being selected, or positions before that job data (S810). In a case that the job data to be deleted is not the job data, which is in a state of being selected, and does not position before that job data (“NO” in S810), the CPU 111 redisplays the job data in the list displaying area 202 without changing a displaying position of the job data (S811).

In a case that the job data to be deleted is the job data, which is in a state of being selected, or positions before the job data which is in a state of being selected (“YES” in S810), the CPU 111 changes a displaying position of the job data and redisplays the job data in the list displaying area 202 (S812). After redisplaying the job data in the list displaying area 202 in S807, 5811 and S812, the CPU 111 updates the number of job data n in the printing job list and terminates a series of processes (S808).

As described above, in a case that the job data, which has been displayed in the list displaying area 202, is in a state of being selected by the user, even if the addition or deletion of the job data is performed, the job data, which is in a state of being selected, can be remained and displayed in the list displaying area 202. Therefore, when the user intends to perform some operation by selecting the job data, a trouble of missing the job data, which is subjected to be operated, due to a fact that the job data is added to the printing job list and deviated from the list displaying area 202 does not occur. When the user intends to perform some operation to the job data which is in a state of being selected, the confusion of a user due to a fact that the selected job data becomes not to be displayed by the unexpected deletion of the job data can be avoided, and operability can be improved.

<Process 2 when User is Selecting Job Data>

When the job data, which has been displayed in the list displaying area 202, is selected by a user, if the job data is added to or deleted from the printing job list, the information processing apparatus 101 may perform the following process instead of the above process. FIGS. 11A and 11B and FIGS. 12A and 12B are diagrams which simplify the list displaying area 202 illustrated in FIG. 2. In FIGS. 11A and 11B and FIGS. 12A and 12B, the number of job data N which can be displayed in the list displaying area 202 is “5”.

FIGS. 11A and 11B are diagrams illustrating shifts of displaying when the job data is added to the printing job list. FIG. 11A, which is the same as FIG. 8A, is a displaying example of the list displaying area 202 when the number of all the job data n in the printing job list is “3”. Three job data, of which the data name 305 are “AAA”, “BBB” and “CCC”, are displayed in the list displaying area 202. The job data, of which the data name 305 is “CCC”, is in a state of being selected by the user, and this job data is displayed with a displaying form different from that of other job data.

FIG. 11B is a displaying example of the list displaying area 202 when the job data is added in FIG. 11A. In FIG. 11B, the job data, of which the data name 305 is “BBB′”, is added between the job data, of which the data name 305 are “BBB” and “CCC”, with a state indicated in FIG. 11A. In this case, the number of the job data n after adding the job data is in a state of “n<N”, and the job data is added before the job data which is in a state of being selected. The job data, which is in a state of being selected, is displayed without shifting a displaying position in the list displaying area 202. Since the numbers n and N are in a state of “n<N”, the job data can be still additionally displayed in the list displaying area 202. However, the job data, of which the data name 305 is “AAA”, to be displayed at the head in the displaying area is not displayed in the list displaying area 202 in order that a displaying position of the job data, which is in a state of being selected, is not shifted. By that, the length of the scroll bar slider 205 becomes shorter than that of the scroll bar 204, and the scroll bar slider 205 is displayed in a manner that it positions at the lower part of the scroll bar 204.

FIGS. 12A and 12B are diagrams illustrating shifts of displaying when the job data is deleted from the printing job list. FIG. 12A, which is the same as FIG. 9A, is a displaying example of the list displaying area 202 when the number of all the job data n in the printing job list is “10”. In FIG. 12A, five job data at the latter part in the printing job list, which is configured with ten job data, of which the data name 305 are “AAA” to “JJJ”, are displayed. The length of the scroll bar slider 205 is half length of that of the scroll bar 204, and the scroll bar slider 205 positions at the rear edge part of the scroll bar 204. The job data, of which the name 305 is “HHH”, is in a state of being selected by the user, and this job data is displayed with a displaying form different from that of other job data.

FIG. 12B is a displaying example of the list displaying area 202 when the job data is deleted in FIG. 12A. In FIG. 12B, the job data, of which the data name 305 are “AAA” to “FFF”, are deleted from the state in FIG. 12A. The number of job data n after deleting the job data is in a state of “n<N”, and the job data before the selected job data are deleted. The job data, which is in a state of being selected, is displayed without shifting a displaying position in the list displaying area 202. An area, where the job data, of which the data name 305 is “FFF”, has been displayed, becomes a non-displaying area.

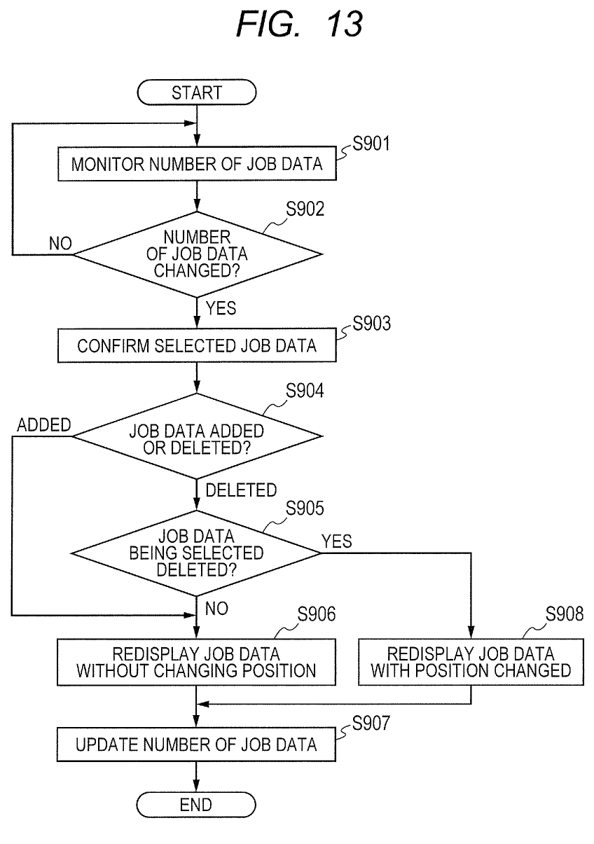

FIG. 13 is a flow chart indicating a processing procedure of the information processing apparatus 101 in order to realize the displaying as in FIGS. 11A and 11B and FIGS. 12A and 12B. Each of the steps in this flow chart is completed by a process that the CPU 111 executes control programs stored in the ROM 113 or the external memory 121.

Processes in S901 to S904 are the same as those in S801 to S804 in FIG. 10. However, in 5903, the CPU 111 also confirms a displaying position of the job data being selected by the user. In S904, the CPU 111 judges whether the job data is added to or deleted from the printing job list. When the job data was deleted (“DELETED” in S904), the CPU 111 judges whether or not the job data to be deleted is the job data being selected (S905). In a case that the job data to be deleted is not the job data being selected (“NO” in S905), the CPU 111 redisplays the job data in the list displaying area 202 without changing a displaying position of the job data which is in a state of being selected (S906). In a case that the job data to be deleted is the job data being selected (“YES” in S905), the CPU 111 deletes the selected job data and redisplays the job data in the list displaying area 202 (S908).

In a case that the job data is added to the printing job list by the process in S904 (“ADDED” in S904), the CPU 111 redisplays the job data in the list displaying area 202 without changing a displaying position of the job data, which is in a state of being selected, in the list displaying area 202 (S906).

After redisplaying the job data in the list displaying area 202 according to the process in S906 or S909, the CPU 111 updates the number of job data n in the printing job list and terminates a series of processes (S907).

In this manner, in a case that the job data, which is in a state of being selected, exists, even if the job data is added to or deleted from the printing job list, a displaying position of the job data, which is being selected, in the list displaying area 202 is not changed. Therefore, when the user is paying attention to the job data being selected, even if the job data is added to or deleted from the printing job list, a displaying position of the job data being selected is not moved. Therefore, the user does not lose sight of the job data being selected. In addition, even in a case that the user intends to perform an operation to the job data being selected, since a displaying position of the job data is not moved, such a trouble of erroneously performing an operation to other job data does not occur.

As above, although it has been described in detail based on a preferable embodiment of the present invention, the present invention is not limited to the specific embodiment but also includes various forms within a scope which does not deviate from the purpose of the present invention. In addition, a part of the above embodiment may be suitably combined. Further, the above information processing apparatus 101 includes various apparatuses. For example, as the various apparatuses, it is not limited to a personal computer, a PDA (personal digital assistant) or a mobile phone terminal, but includes a printer, a scanner, a FAX (facsimile machine), a copying machine, a multifunction machine, a camera, a video camera, other image viewer and the like.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, when the new data is added between the data not displayed in the list displaying area and when the data not displayed in the list displaying area is deleted, the displaying of the list displaying area is not updated. Consequently, even in the case where the data increases and decreases in number irrespective of the operation of the user, it is possible to prevent that the list displaying is updated and thus the data to which the user pays attention or which is intended to be manipulated or operated by the user suddenly disappears from the list displaying area. As a result, it is possible to prevent that user's operability deteriorates.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-128476, filed Jun. 19, 2013, which is hereby incorporated by reference herein in its entirety.

What is claimed is:

1. An information processing apparatus comprising:
a storing unit configured to store a list of data of which the number increases and decreases irrespective of a direct operation of a user;
a displaying unit configured to include a list displaying area for displaying, among the data in the list, a predetermined number of the data in the order of the list;
a list updating unit configured to add data to the list or delete the data from the list; and
a controlling unit configured to control to update a content to be displayed by the displaying unit, according to the addition or the deletion of the data by the list updating unit, wherein
the controlling unit controls not to change the data to be displayed in the list displaying area, when new data is added between data not displayed in the list displaying area and when data not displayed in the list displaying area is deleted.

2. The information processing apparatus according to claim 1, wherein the controlling unit controls to change the data to be displayed in the list displaying area, when new data is added between the data displayed in the list displaying area and when the data displayed in the list displaying area is deleted.

3. The information processing apparatus according to claim 1, further comprising a confirming unit configured to confirm that any of the data to be displayed in the list displaying area has been selected by the user, wherein
in a case where the data selected by the user is confirmed by the confirming unit, the controlling unit controls, when updating the content to be displayed by the displaying unit, to update the displaying such that the selected data remains in the list displaying area.

4. The information processing apparatus according to claim 3, wherein
the confirming unit confirms a displaying position of the data selected by the user in the list displaying area, and
the controlling unit controls, when updating the content to be displayed by the displaying unit, to update the displaying such that the selected data remains at the confirmed displaying position in the list displaying area.

5. The information processing apparatus according to claim 1, wherein the data stored by the storing unit includes job data.

6. The information processing apparatus according to claim 5, wherein the list updating unit adds the job data to the list according as a job is added, and deletes the job data from the list according as the job is completed.

7. The information processing apparatus according to claim 5, further comprising a printing unit configured to execute a printing job to print an image, wherein
the job data to be stored by the storing unit includes job data concerning the printing job to be executed by the printing unit.

8. A method which is performed by an information processing apparatus connected to a display, the method comprising:
displaying, on the display, a predetermined number of data included in a list of the data of which the number increases and decreases irrespective of a direct operation of a user, in the order of the list;
monitoring addition or deletion of the data to or from the list;
changing, in a case where new data is added between the data displayed on the display, the data to be displayed on the display;
not changing, in a case where new data is added between data not displayed on the display, the data to be displayed on the display;
changing, in a case where the data displayed on the display is deleted, the data to be displayed on the display; and
not changing, in a case where data not displayed on the display is deleted, the data to be displayed on the display.

9. A non-transitory computer-readable storage medium which stores a computer program for causing a computer connected to a display to perform:
a process of displaying, on the display, a predetermined number of data included in a list of the data of which the number increases and decreases irrespective of a direct operation of a user, in the order of the list;
a process of monitoring addition or deletion of the data to or from the list;
a process of changing, in a case where new data is added between the data displayed on the display, the data to be displayed on the display;
a process of not changing, in a case where new data is added between data not displayed on the display, the data to be displayed on the display;
a process of changing, in a case where the data displayed on the display is deleted, the data to be displayed on the display; and
a process of not changing, in a case where data not displayed on the display is deleted, the data to be displayed on the display.
